(19) United States
(12) Patent Application Publication
(10) Pub. No.: US 2014/0214340 A1
(43) Pub. Date: Jul. 31, 2014

(54) APPARATUS AND METHOD FOR DETECTING AT LEAST ONE PERIODICALLY OCCURRING DEFECT ON AN OBJECT

(71) Applicants: Thomas Pfatschbacher, Kirchschlag (AT); Johann Reisinger, Plesching-Steyregg (AT); Norbert Gstoettenbauer, Engerwitzdorf (AT); Stefan Schuster, Enns (AT); Karsten Lothar Feiste, Hannover (DE)

(72) Inventors: Thomas Pfatschbacher, Kirchschlag (AT); Johann Reisinger, Plesching-Steyregg (AT); Norbert Gstoettenbauer, Engerwitzdorf (AT); Stefan Schuster, Enns (AT); Karsten Lothar Feiste, Hannover (DE)

(73) Assignee: VOESTALPINE STAHL GMBH, Linz (AT)

(21) Appl. No.: 14/232,753

(22) PCT Filed: Jul. 16, 2012
(86) PCT No.: PCT/AT2012/050107

§ 371 Date: Mar. 6, 2014

(30) Foreign Application Priority Data
Jul. 15, 2011 (AT) A 1043/2011

(51) Int. Cl. G01N 27/82

(52) U.S. Cl. CPC G01N 27/82
USPC 702/38

(57) ABSTRACT

An apparatus and a method for detecting at least one periodically occurring defect on an object, in particular on a metal strip, in which at least one time signal is recorded from the moving object using a measuring method, the time signal is converted into a quality function using a stochastic method and one or more periodic signals in the time signal are inferred on the basis of this quality function in order to thereby detect at least one periodically occurring defect on the object. In order to obtain advantageous method properties, it is proposed to convert the time signal recorded by means of the measuring method, in particular the electromagnetic measuring method, into the quality function using a model-based estimation method, in particular using a maximum likelihood method.

### TECHNICAL FIELD

The invention deals with an apparatus and a method for detection of at least one periodically occurring defect on an object, particularly on a metal strip, in which at least one time signal is recorded from the moving object, using a measurement method, the time signal is converted into a quality function, using a stochastic method, and on the basis of this quality function, a conclusion is drawn concerning one or more periodic signals in the time signal, in order to thereby determine at least one periodically occurring defect on the object.

### STATE OF THE ART

In order to be able to detect periodic roll marks on a metal strip, DE3855913T2 proposes subjecting measurement signals or time signals that are optically recorded using a camera to an autocorrelation method. Such a stochastic method now transforms this time signal into a quality function, thereby making it possible to recognize periodic signals and to draw a conclusion concerning roll marks or strip defects. In general, it is mentioned that the quality function indicates the likelihood of rejection of the zero hypothesis as a function of the true value of the parameter to be checked, in other words illustrates the ability of the parameter test to recognize an incorrect hypothesis as incorrect and a correct hypothesis as correct. It is disadvantageous, in such an autocorrelation method, that process-related variations can have a significant influence on the detection rate of the autocorrelation method. In this connection, even taking the strip speed of the metal strip into consideration cannot result in any significant improvement of the detection rate. Furthermore, autocorrelation methods have significant problems in the detection of comparatively small strip defects, in terms of their geometric dimensions, and in the detection of more than one periodically occurring defect, and therefore it is not possible to ensure a stable method.

### PRESENTATION OF THE INVENTION

The invention has therefore set itself the task of improving a method for the detection of strip defects, of the type described initially, in such a manner that strip defects can be recognized with comparatively great precision and reliability, with slight changes in the method. Furthermore, the method is supposed to be able to demonstrate great stability even in the detection of multiple periodic defects.

The invention accomplishes the stated task in that the time signal, recorded using the particularly electromagnetic measurement method, is converted into the quality function using a model-based estimation method, particularly using a maximum likelihood method.

If the time signal, by means of the, is converted into the quality function using a model-based estimation method, then in contrast to the state of the art, a periodic strip defect can be recognized in particularly reliable manner. This is because using the model-based estimation method, an extremely sensitive stochastic method can be created, thereby making it possible to still recognize periodic signals even in a comparatively noisy time signal. A comparatively great detection sensitivity, using merely one time signal, can thereby be guaranteed, whereby if necessary, various model uncertainties, such as slip, strip length changes, etc., can be taken into consideration in this connection. In addition, this method can ensure particularly advantageous measurement conditions even with an electromagnetic measurement method. This is because even time signals having greatly varying signal-to-noise ratios and thereby hidden periodic signals can be reliably analyzed with regard to periodic components or signals, on the basis of distance variations between the sensor and the moving metal strip. The method is therefore not only comparatively tolerant and stable with regard to disadvantageous measurement influences on the time signal to be analyzed, but also can ensure a comparatively high recognition rate for strip defects, with improved resolution. In particular, a maximum likelihood method can distinguish itself for the detection of defects on a moving object or metal strip. This method can be particularly suitable for deriving an estimator by way of which a conclusion can be drawn concerning one or more periodic signals in the time signal, the periodicity of which signals is unknown. Non-periodic interference signals can be particularly suppressed with this, and this can increase the number of recognizable strip defects in simple manner. Furthermore, using the method according to the invention, the possibility can be opened up of detecting multiple periodic defects on the object in parallel and without any reciprocal interference of the same. The method according to the invention is therefore not only stable, but also can be used in particularly flexible and simple manner.

In general, it should be mentioned as an example that conversion of a time signal to a quality function can be made possible in that
a squared amount spectrum is calculated from a time signal, by way of Fourier transformation, and
then a quality function is determined for all the possible base periods/base frequencies, which function is an addition of the squared amount spectrum at the base frequency and all whole-number multiples.

The sensitivity of the method with regard to periodically occurring defects in the time signal can be further increased if at least one characteristic of the error-specific signal is taken into consideration in the model-based estimation method. According to the invention, in this way the quality function can specifically contain a weighting, can result in a new calculation regulation for the quality function, or can lead to a new mathematical structure, and thereby make the highest recognition rates of periodically occurring defects on the object possible. In particular, a mathematical model of the signal progression can distinguish itself for the formation of this weighting, in order to sensitize the quality function to the periodically occurring defect. However, it is possible to take other characteristics into consideration in the model-based estimation method. According to the invention, the method can thereby be configured to be particularly stable with regard to interference, and to recognize roll marks or strip defects on a metallic strip, particularly sheet metal, in particularly reproducible manner.

Simple method conditions can furthermore result if the time signal is subjected to an integral transformation, particularly to Fourier transformation. Furthermore, in this way an extremely rapid method can be ensured.

If an electromagnetic sensor is positioned over the object using at least one air cushion, for the magnet-inductive measurement method, then in this way, the resolution can be clearly increased. Measurement-related variations in the signal-to-noise ratio can be reduced in their number, because distance variations caused by strip movements away from or toward the sensor can be compensated by the air cushion.

The reproducibility of the method can be improved even further in that at least two time signals measured on the object are used in order to recognize at least one interference that occurs in both time signals and to suppress it in the method. This is because it can be assumed that a periodically occurring defect will have an effect in only one of the two time signals. However, interferences occur equally in both time signals, and this can be recognized. Alternatively, however, it is also possible to use at least two different time ranges of a time signal, to recognize at least one interference that occurs in the two time ranges of the time signal, and to suppress it in the method. According to the invention, in this way interference signals can be suppressed in the time signal that has the error-specific signal, and this can increase the resolution of the method even further. Roll marks or strip defects on a metallic strip, particularly sheet metal, can thereby be recognized by the method in extremely reliable manner.

Simple method conditions can result if the interference is suppressed by means of adaptive filtering.

If the sensor is moved over the width of the object for the measurement method, then a comparatively wide object can be examined for defects in a simple method of procedure. For this purpose, at least one time signal merely has to be recorded in a movement position of the sensor, before the sensor is moved further. In this way, the defects, which are disposed in stripe-like manner in the longitudinal direction of the object, because of their periodicity, can be detected with simple method steps. Furthermore, it is possible to do without reconciliation of sensors when there is only one sensor, so that the method according to the invention can also be comparatively simple to handle.

Also, multiple sensors disposed offset relative to one another with regard to the object can be provided for the measurement method, and can record time signals from the metal strip, in each instance. In this way, rapid detection of defects can be made possible, because parallel signal evaluation or assessment can take place. Such methods can particularly distinguish themselves in continuous production methods of metal sheets.

The use of a model-based estimation method, particularly a maximum likelihood method, can particularly distinguish itself especially for the calculation of a quality function for a time signal recorded from a moving object, using an electromagnetic measurement method, for the detection of periodic defects on the object.

The invention has furthermore set itself the task of creating an apparatus of the type described initially, with which great detection sensitivity, particularly also in the case of small defects, can be recognized in stable manner. Furthermore, the apparatus is supposed to be simple in terms of design.

The invention accomplishes the stated task with regard to the method in that the memory has data regarding a model-based estimation method, particularly a maximum likelihood method, whereby the calculation unit is connected with the memory for conversion of the time signal, particularly recorded by means of an electromagnetic measurement method, to the quality function, using the model-based estimation method, particularly using a maximum likelihood method.

If the memory has data concerning a model-based estimation method, whereby the calculation unit is connected with the memory for conversion of the time signal, particularly recorded by means of an electromagnetic measurement method, to the quality function, using the model-based estimation method, particularly using a maximum likelihood method, then even small defects on the object, which generally cannot be recognized with the naked eye, can be reliably detected. In this way, an apparatus having great sensitivity can be created with a comparatively small design change, namely merely a change in the data of the memory of the calculation device.

The stability of the method can be improved even further in that the memory has data concerning at least one characteristic of the defect-specific signal, whereby the calculation unit is connected with the memory in order to take this characteristic into consideration in the method for the detection of periodic defects. In this way, specifically, even the smallest periodic signals can be separated or differentiated from measurement noise, because in this way, a quality function can contain a weighting that can create sensitization of the periodic defect. It is advantageous that a mathematical model concerning the signal progression of the defect-specific signal can be used for this weighting. The apparatus can therefore recognize periodic defects on the moving object in particularly reliable manner.

This sensitivity of the apparatus with regard to a periodic defect on the moving object can be improved even further if the sensor device measures at least two time signals from the object and if the apparatus has an adaptive filter connected with the sensor device, for suppression of at least one interference that occurs in both time signals.

Alternatively, the sensitivity of the apparatus can also be increased in that the apparatus comprises a memory connected with the sensor, for at least two different time ranges of the time signal of the sensor, and that the apparatus has an adaptive filter connected with the memory, for suppression of at least one interference that occurs in both time ranges of the time signal.

Design simplicity of the apparatus can result in that the sensor device has at least two sensors disposed offset from one another, in order to record two time signals from the object in parallel.

Simple design conditions for positioning of a sensor above a moving material can result if the sensor is provided in a slide shoe having pressure outlet openings for generating an air cushion between at least the sensor and the object.

If the sensor device comprises a magnet-inductive sensor, then an apparatus that is particularly robust with regard to interference can result. Furthermore, design simplicity can be ensured using such a sensor.

### BRIEF DESCRIPTION OF THE DRAWING

In the figures, the invention is shown as an example, using an exemplary embodiment. The figures show:

FIG. 1 an apparatus for implementation of the method, with a metal strip, reduced in the drawing,

FIG. 2 a measurement signal from the sensor of the apparatus according to FIG. 1,

FIG. 3 a time signal of the method according to the invention,

FIG. 4 an enlarged detail of the amount spectrum of the time signal according to FIG. 3,

FIG. 5 a quality function from the time signal measured according to FIG. 4, for detection of periodic defects,

FIG. 6 a quality function of another measured time signal,

FIG. 7 a weighted quality function shown in contrast to the quality function shown in FIG. 6,

FIG. 8 an enlarged view of the sensor positioned with regard to the metal strip,

FIG. 9 variants concerning the placement of a sensor device with regard to the metal strip,

FIG. 10 the apparatus according to FIG. 1 in an overall representation, and

FIG. 11 a sensor device alternative to the sensor device shown in FIG. 10.

### WAY TO IMPLEMENT THE INVENTION

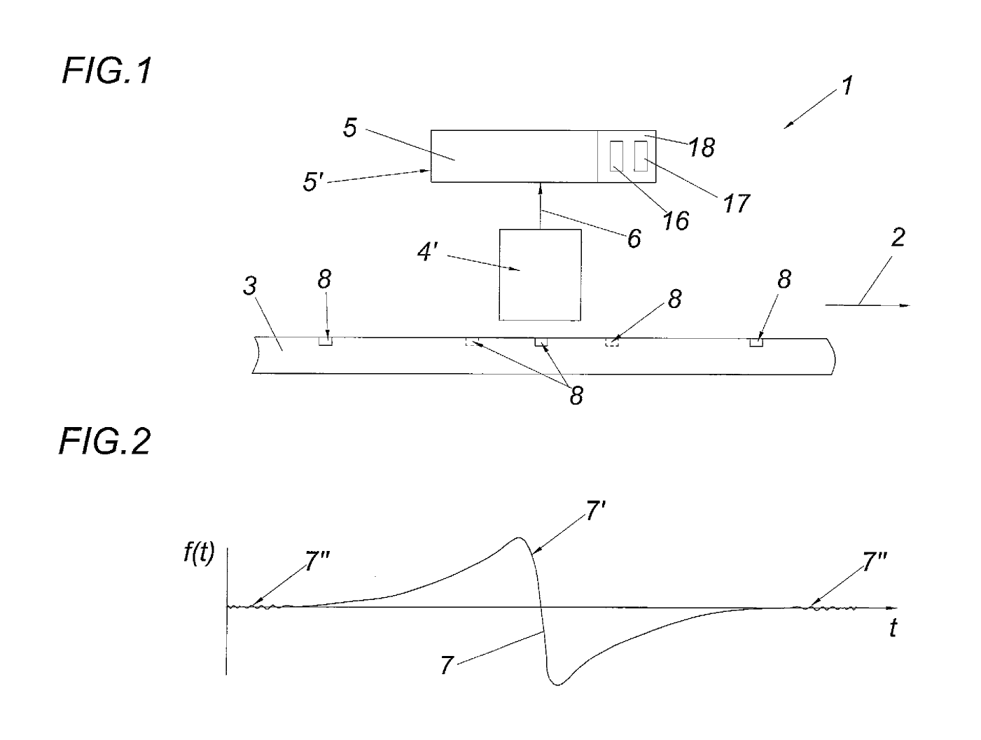

The apparatus 1 shown as an example according to FIGS. 1 and 10 has a sensor 4 positioned opposite an object 3 that moves in the longitudinal direction and works in differential manner, of a sensor device 4′, whereby the object 3 represents a metal strip 3, for example. The sensor 4 is connected with a calculation unit 5 of the calculation device 5′ and transmits measurement data 6 that demonstrate a dependence on a time signal 7 that is recorded from the metal strip 3, using measurement technology. The moving metal strip 3 furthermore has a repeating strip defect 8, which is detected by way of the sensor 4, during the course of the measurement method, as can be recognized, in particular, in FIG. 2, on the basis of the amplitude deflection f(t). The time signal 7 is composed of a superimposition of a periodic signal 7′ and an interference component 7″, and therefore also contains a characteristic that depends on a strip defect 8. The time signal 7 is converted into a quality function 9 by way of a stochastic method. On the basis of this quality function 9, a conclusion is drawn concerning a periodic signal 7′ in the time signal 7, in order to thereby detect the periodically occurring strip defect 8 on the metal strip. These strip defects can also occur on the surface of the metal strip 3 and/or also in the metal strip 3. In order to make particularly great robustness with regard to measurement technology interference in magnet-inductive measurement methods possible, according to the invention, and to make a high detection rate of strip defects 8 possible, it is proposed, according to the invention, that the time signal 7 is converted into the quality function 9 by using a maximum likelihood method. In particular, the maximum likelihood method has proven to be advantageous as a model-based estimation method for time signals 7 from magnet-inductive measurement methods.

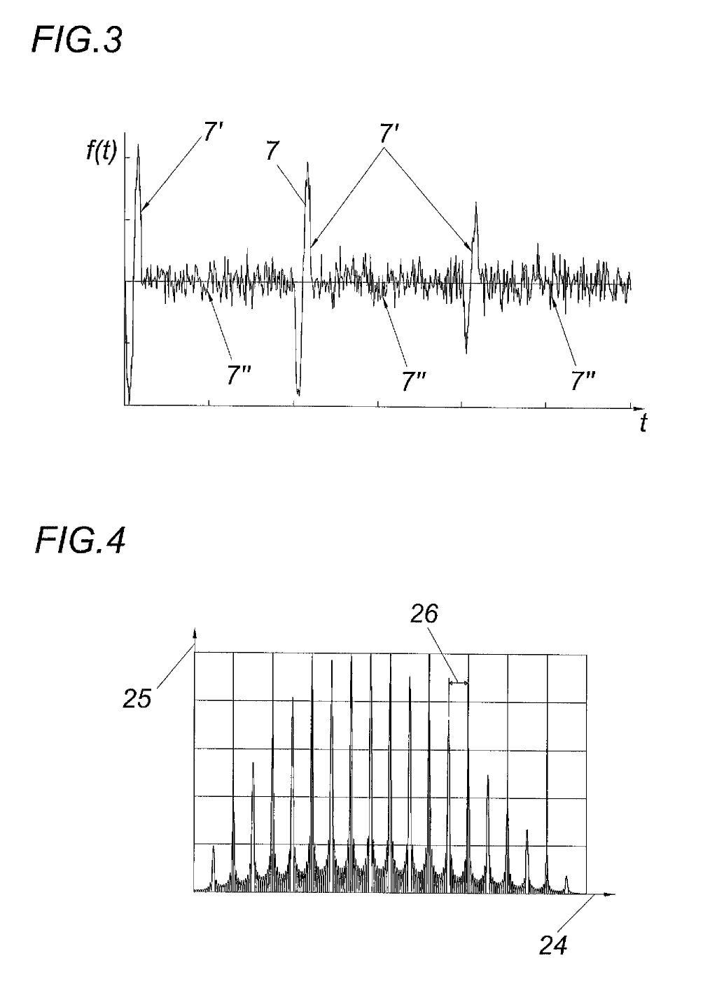

An example of or a result of the use of the maximum likelihood method for calculation of a quality function 9 for the detection of a periodic signal in Gaussian measurement noise according to FIG. 3 can be given by the following formula (cf. “Multi Pitch Estimation”—Anderas Jakobsson et al—ISBN 9781598298363):

$$J ( τ ) = {\sum }_{k = 1}^{L} {\vert X ( \frac{1}{τ} \cdot k ) \vert}^{2}$$

X represents the Fourier-transformed value as an integral transformation of the time signal 7, preferably implemented with the Fast Fourier Transformation algorithm for calculation time efficiency.
L is the number of the harmonics, whereby different methods are known in the literature for calculation/selection of L.
τ represents the possible period durations that are supposed to be investigated.

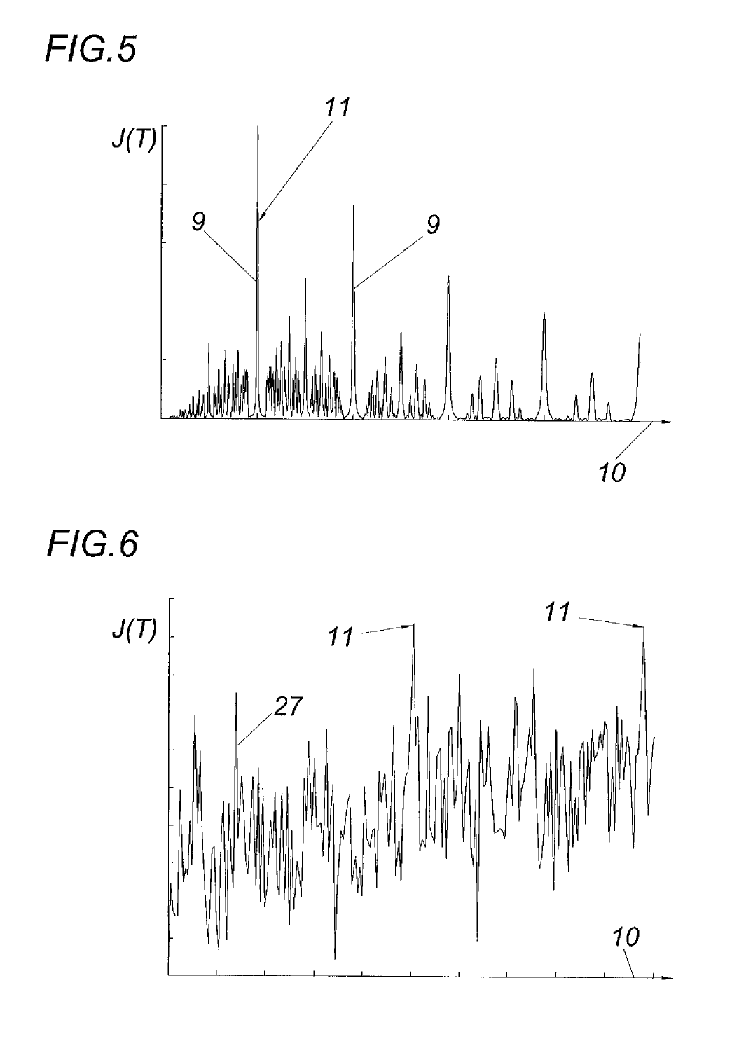

The quality function 9 or J(τ) is therefore calculated as the sum by way of the entries of the squared amount spectrum, of the frequency that belongs to a possible period duration and its harmonics, calculated for all possible period durations. A detail of such an amount spectrum is shown in FIG. 4, whereby this amount spectrum is plotted over the normalized frequency 24 on the one side and over the normalized amount spectrum 25 on the other side. The distance 26 represents the 1/normalized period duration. A possible resulting quality function 9 is shown in FIG. 5.

This normalized quality function 9, plotted over the normalized period duration 10 in FIG. 5, has maxima 11, on the basis of which maxima 11 a conclusion can be drawn concerning a period signal 7′ in the time signal 7. The position of the maximum 11 of the quality function 9 provides information concerning the periodicity of the signal 7′, while the height of the quality function 9 can be used as a decision criterion concerning the presence of a periodic signal 7′.

A periodic signal 7′ that is present in the time signal 7 according to FIG. 3 can therefore be determined with particularly great detection sensitivity. This is true even if, as shown in FIG. 3, an amplitude maximum that is reduced over time can be found in the signal 7′. This circumstance can occur, for example, because the general conditions of the measurement method change due to strip vibrations, and therefore the signal-to-noise ratio can also be reduced, in disadvantageous manner. This circumstance can be taken into consideration in simple manner, in terms of method technology, for the stochastic method according to the invention, so that this method is particularly stable with regard to measurement technology interference.

The resolution of the method is improved in that a mathematical model, for example f_{defect}=sin(t), is taken into consideration with regard to the signal progression of the defect-specific signal 7′, namely in the model-based estimation method. The quality function 9 or J(τ) thereby contains a weighting, as can be represented as follows, for example:

$$J ( τ ) = {\sum }_{k = 1}^{L} \vert {A ( \frac{1}{τ} \cdot k )}^{2} \vert {\vert X ( \frac{1}{τ} \cdot k ) \vert}^{2}$$

A represents a weighting that can be formed, for example, from the Fourier-transformed value of the defect-specific signal 7′ that can be assumed to be known.

The progression of the defect-specific signal 7′ can be seen in FIG. 2, according to which a sine is used as an approximation to the differential signal progression of the sensor signal. However, it is certainly possible to take other characteristics of the defect-specific signal 7′ into consideration in the weighting of the quality function 9 or J(τ).

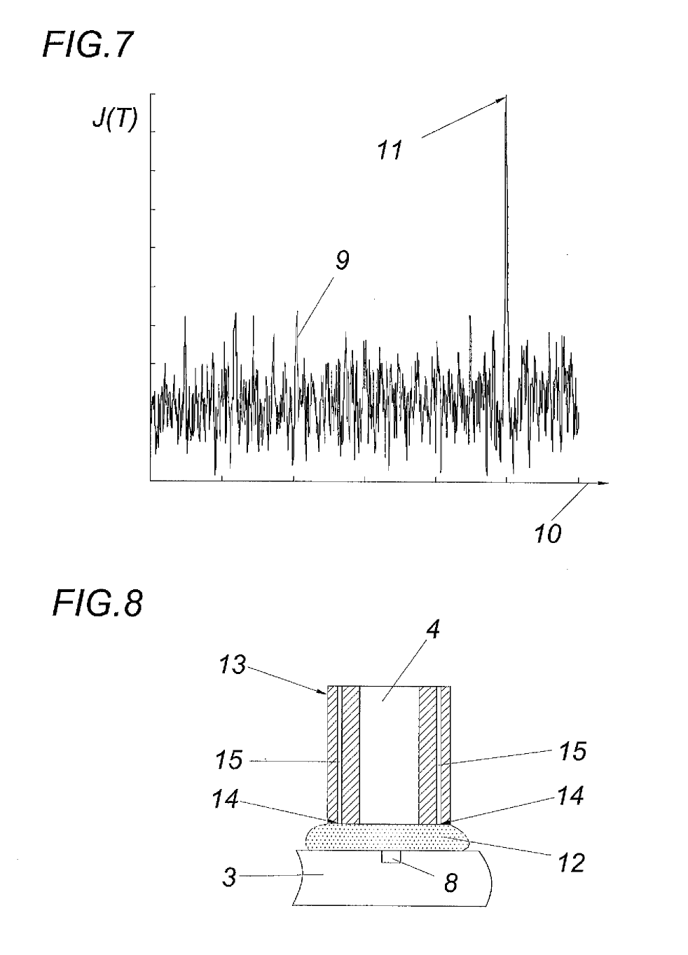

In a comparison between FIGS. 6 and 7, the advantage of the weighting can be better recognized. In the normalized quality function 27, plotted over the standardized period duration 10, the maximum 11 that indicates a periodic signal 7′ cannot be clearly recognized, in comparison with the quality function 9 shown according to FIG. 5. Such a quality function 27 can occur, for example, as the result of a very noisy time signal, which time signal is not shown in any detail. If now the quality function 27 is weighted with characteristics of the defect-specific signal 7′, a maximum 11 can be clearly recognized in this quality function 9 shown according to FIG. 7—similar to FIG. 5—on the basis of which maximum 11 a conclusion can be drawn concerning a periodic signal 7′ in the time signal 7. Here, too, the position of the maximum 11 of the quality function 9 provides information about the periodicity of the signal 7′, while the height of the quality function 9 can be used as a decision criterion concerning the presence of a period signal 7′. The comparatively very noisy time signal that led to a quality function 27 should be analyzed successfully, once again, with a weighted quality function 9, with regard to roll marks or strip defects.

For the magnet-inductive measurement method, the electromagnetic sensor 4 is positioned above the object 3 or the metal strip, using at least one air cushion 12, as can particularly be seen in FIG. 8. For this purpose, the sensor 4 is provided in a slide shoe 13, in a simple design. The slide shoe 13 has pressure outlet openings 14 that are connected with a compressed air line 15 of a compressed air device, not shown in any detail, for production of an air cushion 12 between sensor 4 and metal strip 3.

Design simplicity results from the fact that the data 16, 17 that the calculation unit 5 needs to carry out the method, among other things, are stored in a memory 18 of the calculation device 5. In this way, the calculation device 5 can easily connect with the memory in order to call up the data concerning the maximum likelihood method or to use them for the purpose of converting the time signal 7 into the quality function 9.

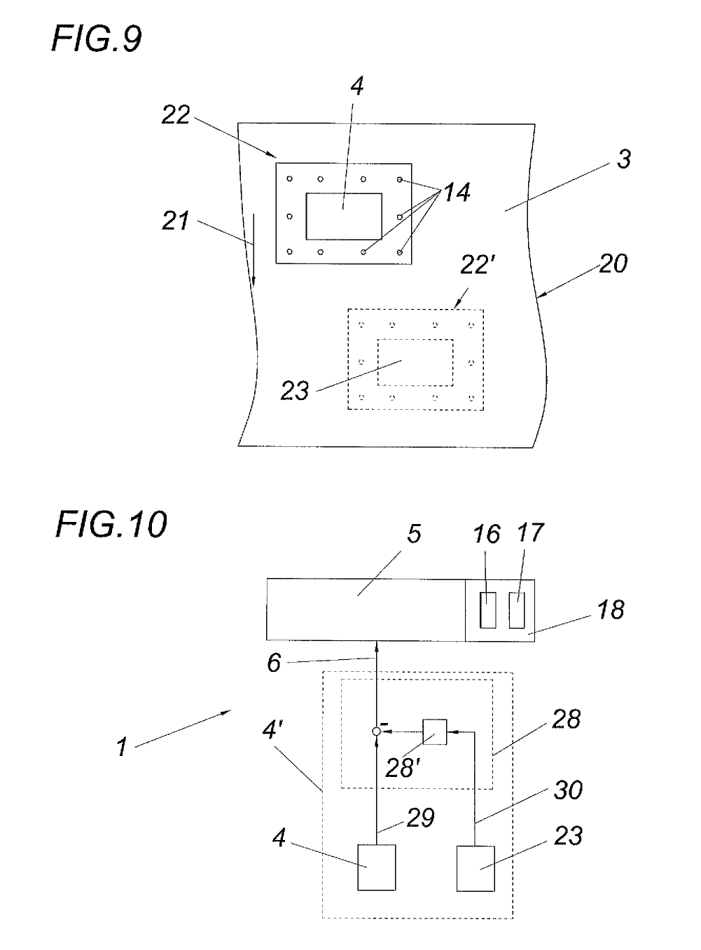

The defects 8 that occur over the width 20 of the metal strip 3 can be detected in that the sensor 4 is moved over the width 20 of the metal strip 3 during the course of the measurement method, as has been indicated in FIG. 9 with a movement direction 21. Thus, a time signal 7 can now be recorded in a movement position 22 of the sensor 4, in order to examine this signal for periodic defects 8 on the metal strip 3. Subsequently, the sensor 4 can be moved on to a different movement position 22′. In combination with this or alternatively to this, it is possible to dispose multiple sensors 4, 23 disposed offset from one another with regard to the metal strip 3, and to record time signals 7 from the metal strip 3, in each instance, which then are each analyzed for periodic time signals 7′.

In FIG. 10, the apparatus 1 is shown in its entirety. The sensor device 4′ shown here has not only the sensor 4 but also a second sensor 23, as well as an adaptive filter 28. The two sensors 4 and 23 Lake measurement signals 29 and 30 from the metal strip 3 and pass these to the adaptive filter 28, which then transmits measurement data 6 to the calculation device. These measurement data 6 demonstrate the dependence from the time signal 7 that was recorded from the metal strip 3 using measurement technology. Because the interference caused by strip variation, for example, is equally contained in the measurement signals 29 and 30, it can be removed from the measurement data 6 if these measurement signals 29 and 30 are subtracted. For this suitable subtraction, the measurement signal 30 is still adapted using suitable means 28′. According to the invention, the measurement data 6 are now corrected by means of the adaptive filter 28, to the effect that an interference that occurs in both time signals 7 is suppressed.

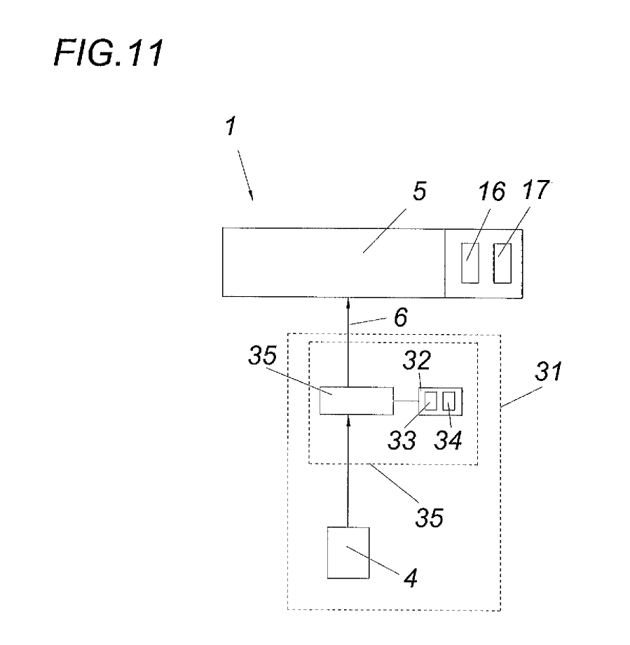

According to FIG. 11, an alternative sensor device 31 of the apparatus 1 is shown for interference reduction. This sensor device 31 comprises a memory 32 connected with the sensor 4, for storing at least two different time ranges 33, 34 of the time signal 7 of the sensor 4. These time ranges 33, 34 are now passed to an adaptive filter 35 that suppresses an interference that occurs in both time ranges of the time signal, in order to thereby correct the measurement data 6.

1. Method for detection of at least one periodically occurring defect (8) on an object (3), particularly on a metal strip, in which at least one time signal (7) is recorded from the moving object (3), using a measurement method, the time signal (7) is converted into a quality function (9), using a stochastic method, and on the basis of this quality function (9), a conclusion is drawn concerning one or more periodic signals (7′) in the time signal (7), in order to thereby determine at least one periodically occurring defect (8) on the object (3), wherein the time signal (7), recorded using the particularly electromagnetic measurement method, is converted into the quality function (9) using a model-based estimation method, particularly using a maximum likelihood method.

2. Method according to claim 1, wherein in the model-based estimation method, at least one characteristic of the defect-specific signal (7′), particularly a mathematical mode (fdefect) concerning its signal progression, is taken into consideration.

3. Method according to claim 1, wherein the time signal (7) is subjected to an integral transformation, particularly a Fourier transformation.

4. Method according to claim 1, wherein an electromagnetic sensor (4) is positioned above the object (3) using at least one air cushion (12), for the magnet-inductive measurement method.

5. Method according to one claim 1, wherein at least two measured time signals (7) from the object (3) or at least two different time ranges of a time signal (7) are used, in order to recognize at least one interference that occurs in both time signals (7) or in both time ranges of the time signal (7).

6. Method according to claim 5, wherein the method suppresses an interference by means of adaptive filtering.

7. Method according to claim 1, wherein for the measurement method, the sensor (4) is moved over the width (20) of the object (3), wherein at least one time signal (7) is recorded in a movement position (22) of the sensor (4) before the sensor (4) is moved further.

8. Method according to claim 1, wherein for the measurement method, multiple sensors (4, 23) disposed offset from one another are disposed opposite the object (3) and record time signals (7) from the object (3), in each instance.

9. Use of a model-based estimation method, particularly a maximum likelihood method, for calculation of a quality function (9) for a time signal (7) recorded from a moving object (3), using an electromagnetic measurement method, for detection of periodic defects (8) on the object (3).

10. Apparatus for detection of at least one periodically occurring defect (8) on a moving object (3), particularly on a metal strip, having a sensor device (4′) for recording at least one time signal measured from the object (3), having a calculation device (5′) connected with the sensor device and having a memory (18) and a calculation unit (5), for converting the time signal (7) into a quality function (9), using a stochastic method, and for drawing conclusions on the basis of this quality function (9), concerning at least one periodic signal (7′) in the time signal, in order to thereby determine at least one periodically occurring defect (8) on the object (3), wherein the memory (18) has data (16) regarding a model-based estimation method, particularly a maximum likelihood method, wherein the calculation unit (5) is connected with the memory (18) for conversion of the time signal (7), particularly recorded by means of an electromagnetic measurement method, into the quality function (9), using the model-based estimation method, particularly using a maximum likelihood method.

11. Apparatus according to claim 10, wherein the memory (18) has data (17) concerning at least one characteristic of the defect-specific signal (7′), particularly a mathematical model (fdefect) concerning the signal progression of the defect-specific signal (7′), wherein the calculation unit (5) is connected with the memory (18) in order to take this characteristic into consideration in the method for the detection of periodic defects (8).

12. Apparatus according to claim 10, wherein the sensor device (4′) measures at least two time signals (7) from the object (3) and wherein the apparatus (1) has an adaptive filter (28) connected with the sensor device (4′), for suppression of at least one interference that occurs in both time signals (7).

13. Apparatus according to claim 10, wherein the apparatus (1) comprises a memory (32) connected with the sensor (4), for at least two different time ranges (33, 34) of the time signal (7) of the sensor (4), and wherein the apparatus (1) has an adaptive filter (35) connected with the memory (32), for suppression of at least one interference that occurs in both time ranges (33, 34) of the time signal (7).

14. Apparatus according to claim 10, wherein the sensor (4) is provided in a slide shoe (13) having pressure outlet openings (14) for generating an air cushion (12) between at least the sensor (4) and the object (3).

15. Apparatus according to claim 10, wherein the sensor device (4′) comprises a magnet-inductive sensor (4).
